(19) United States
(12) Patent Application Publication
(10) Pub. No.: US 2025/0299582 A1
(43) Pub. Date: Sep. 25, 2025

(54) SYSTEM AND METHOD FOR DETERMINING A TRAJECTORY BASED ON GEO-FENCING

(71) Applicant: DENSO International America, Inc., Southfield, MI (US)

(72) Inventors: Yichen LI, Ann Arbor, MI (US); Rajesh MALHAN, Troy, MI (US)

(73) Assignee: DENSO International America, Inc., Southfield, MI (US)

(21) Appl. No.: 19/083,518

(22) Filed: Mar. 19, 2025

Related U.S. Application Data
(60) Provisional application No. 63/567,633, filed on Mar. 20, 2024.

(51) Int. Cl. G08G 1/16; G08G 1/01; H04W 4/021

(52) U.S. Cl. CPC G08G 1/166; G08G 1/0116; G08G 1/0129; H04W 4/021

(57) ABSTRACT

A system and method for controlling a road user assistance network includes obtaining historical data, obtaining geo-fence data, generating probabilistic states for a future time, determining spatial proximity data for a feature based on the geo-fence data, generating a prediction based on the probabilistic state and the spatial proximity data, communicating the prediction to a road user or a roadside device and controlling the road user or roadside device based on the prediction.

### CROSS-REFERENCE TO RELATED APPLICATION

This application claims the benefit of U.S. Provisional Application No. 63/567,633 filed on Mar. 20, 2024. The entire disclosure of the above application is incorporated herein by reference.

### TECHNICAL FIELD

The present disclosure relates to a trajectory predictions for vehicles, and, more particularly, to a system and method for.

### BACKGROUND

This section provides background information related to the present disclosure which is not necessarily prior art.

Trajectory prediction is used in safety-critical applications such as autonomous driving, where accurate anticipation of vehicle or pedestrian movements is used to avoid collisions and ensure safe navigation. Traditional trajectory prediction methods often rely solely on historical trajectory data, which may not adequately capture the complexities of real-world environments. Furthermore, these methods may overlook spatial constraints such as lane boundaries and sidewalk boundaries, leading to less reliable predictions, particularly in urban settings.

Existing trajectory prediction approaches face several challenges. First, they may struggle to incorporate contextual information about the surrounding environment, limiting their ability to anticipate dynamic changes in traffic patterns and road conditions. Second, these methods often lack mechanisms to account for spatial constraints, which are crucial for accurately predicting vehicle or pedestrian trajectories in complex urban landscapes.

Recognizing the importance of addressing these challenges, there is a growing emphasis on developing trajectory prediction systems that can integrate contextual information and account for spatial constraints. Such systems have the potential to provide more reliable predictions, enabling proactive measures to prevent accidents and ensure safe navigation in diverse urban environments.

### SUMMARY

This section provides a general summary of the disclosure and is not a comprehensive disclosure of its full scope or all of its features.

The present disclosure provides a system and method that responds to the above-mentioned needs. A comprehensive trajectory prediction and collision avoidance system is set forth. By integrating geo-fence data and historical trajectory data, the present system aims to enhance the reliability and contextual relevance of trajectory predictions. By addressing the limitations of existing methods, the innovative approach offers a promising solution for improving safety in autonomous systems and intelligent transportation.

The system integrates a neural network architecture capable of fusing geo-fence data and historical trajectory data to enhance the reliability and contextual relevance of trajectory predictions. Leveraging spatial constraints from geo-fence data and both spatial and temporal dependencies from historical trajectory data, the neural network generates predicted probabilistic trajectories. Additionally, an auxiliary model operates in conjunction with the neural network architecture to improve the accuracy of near-miss and collision predictions based on the predicted probabilistic trajectories. This model calculates the Time-To-Collision (TTC) between road users within the trajectories, establishing a minimum safe distance and enabling a near-miss detection mechanism to identify potential collision risks. A road user may be a vehicle, pedestrian, or another mobile entities that is equipped with sensors. The system continually evolves predicted trajectories, accepting real-time updates to dynamically adjust positions and refine near-miss predictions. Furthermore, the system adapts to changing environmental conditions by dynamically adjusting the TTC threshold, enhancing the accuracy of near-miss and collision risk predictions. This innovative system offers a robust framework for enhancing safety in autonomous systems and intelligent transportation.

In one aspect of the disclosure, a method for controlling a road user assistance network includes obtaining historical data, obtaining geo-fence data, generating probabilistic states for a future time, determining spatial proximity data for a feature based on the geo-fence data, generating a prediction based on the probabilistic state and the spatial proximity data, communicating the prediction to a road user or a roadside device and controlling the road user or roadside device based on the prediction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a functional block diagram of an example of a road user assistance system in accordance with an embodiment of the present disclosure.

FIG. 2 is a block diagrammatic view of the road user assistance system.

FIG. 3 is a diagrammatic view of a sequential prediction chart.

FIG. 4 is a block diagrammatic view of the collision and near-miss detection system.

FIG. 5 is a flow chart of a meth for operating a collision avoidance system.

Corresponding reference numerals indicate corresponding parts throughout the several views of the drawings.

### DETAILED DESCRIPTION

Example embodiments will now be described more fully with reference to the accompanying drawings.

Recent intelligent vehicles include various sensors and communication devices, which are used to understand host vehicle behavior, driver behavior, and behavior of other vehicles. Road user data is provided based on outputs of the sensors, current operating conditions, and a detected operating environment. For example, a steering wheel angle, a brake pedal position, and an accelerator pedal position may be monitored to determine driver behavior while external radar sensor signals and camera images may be monitored to detect a current vehicle environment, which may include other vehicles. As an example, location and movement of lane markers, surrounding objects, signal lights, etc. may be monitored. Road user may be provided to, for example, autonomously steer, brake and/or decelerate the corresponding host vehicle to prevent a collision.

A modular artificial intelligence (AI) system of a vehicle may perform autonomous actions and operate a vehicle to, for example, merge from a first lane of traffic into a second lane of traffic. A modular AI system is an AI system that is applicable to various vehicle environments and follows a set of rules to predict movement (e.g., travel path, speed, acceleration, etc. of nearby vehicles relative to a host vehicle).

Autonomous driving in past years is a leading focus point in the automotive research field and driving in urban and highway traffic is complex. Given the statistics indicating that the number of fatalities in traffic accidents in the last 10 years is 1.2 million per year, autonomous driving is expected to save millions of lives in the future. Apart from orthodox techniques and in order to provide a vehicle with some self-built intelligence, several machine learning (ML) techniques have been introduced, which allow a driving agent to learn from gathered data and improve future operations based on determined experiences. A “driving agent” or “agent” as used herein may refer to a vehicle, a vehicle control module, a road user module, a RLP module, a simulation system control module, a simulated vehicle control module, or other autonomous vehicle module. An agent may refer to a combination of two or more of the stated modules. Current autonomous methods include vehicle individualized intelligence without collaboration that focus operations based on sensory inputs.

The examples provided herein include collaborative multi-agent reinforcement learning. This may be implemented, for example, on a highway, freeway, roadway, or other multi-vehicle environment. The collaborative multi-agent reinforcement learning approach may also be implemented in an actual vehicle environment, in a simulated environment, or other multi-agent environment where multiple agents are able to interact. Each of the agents is able to learn behaviors of that agent and/or corresponding vehicle and behaviors of the other agents and/or corresponding vehicles. The stated behaviors are learned over time based on feedback data, sensor data, and shared data collected in association with different environment states and performed actions. Collaborative systems are disclosed in which the agents share data about the environment and decision making information and based on this information decide on a best course of action to take next. This includes avoiding obstacles, pedestrians and rogue vehicles, which may be un-instrumented and/or non-autonomous vehicles. This aids in preventing a collision. The collaborative systems include teaching agents to drive autonomously and collaboratively in certain scenarios, such as highway scenarios.

The disclosed agents perform collaborative decision making and path planning using trained and continuous learning artificial intelligence (AI) systems to prevent single and series collisions. A single collision refers to a collision between two vehicles. A series collision refers to a multiple consecutive collisions between more than two vehicles, sometimes referred to as a “traffic pile up”. Certain traffic conditions may be mixed such that the traffic includes autonomous vehicles, partially autonomous vehicles, and/or non-autonomous (manually driven) vehicles. Other traffic conditions may include only fully autonomous vehicles that are fully connected (i.e. able to communicate with each other and share information).

In the disclosed examples, a RLP algorithm (also referred to as a multi-agent collaborative deep Q network (DQN) with prioritized experience replay (PER) algorithm) is disclosed that provides intelligence for behavior prediction of surrounding vehicles and negotiated path prediction and planning for collision avoidance in automated vehicles. The RLP algorithm is used to facilitate autonomous vehicle learning and predicting of vehicle behaviors and potential driving paths of the vehicles in a particular environment (or local traffic scenario). The prediction of vehicle behaviors and driving paths may be for any number of vehicles in a driving scenario. The prediction may include but are not limited to trajectory, collision risk, or near-miss probabilities.

The disclosed implementations also include a reinforcement learning (RL) architecture for collaborative, multi-agent planning which is useful for control of spatially distributed agents in a noisy environment. Collaborative driving is needed for future autonomous driving where several autonomous vehicles are in proximity of each other and are sharing state information, action information, decision information, etc. with each other for informed decision making in real time. Complete state information and intended actions of all of the autonomous vehicles in an environment and position information of non-autonomous vehicles may be shared with each autonomous vehicle. In this scenario, the autonomous vehicles are capable of driving collaboratively with each other while evading the non-autonomous vehicles. These maneuvers may be aggressive. The autonomous vehicles are able to learn from experiences of each other and perform better actions over time.

Although the disclosed figures are primarily described with respect to vehicle implementations, the systems, modules, and devices disclosed herein may be used for other applications, where artificial intelligence decisions are made and course of actions are selected. The examples may be utilized and/or modified for various neural networks.

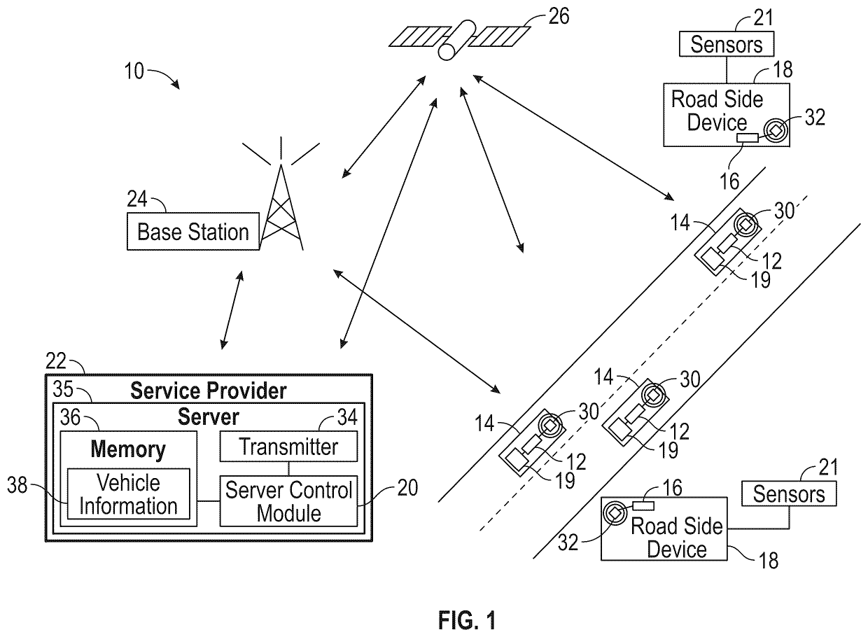

Referring to FIG. 1, a road user network 10 in a mixed autonomous operating environment is illustrated. The road user network 10 may include various vehicle communication devices (or devices that transmit vehicle related information), such as vehicle control modules 12 of vehicles 14, roadside control modules 16 of roadside units (or roadside devices) 18, a server control module 20 of a service provider 22, and/or other vehicles communication devices, such as communication devices in a base station 24 or a satellite 26. The vehicle related information may include messages and/or signals including information pertaining to the vehicles 14 and/or objects within predetermined distances of the vehicles 14. As an example, the server 35 may be implemented as a cloud-based server and the server control module 20 may be implemented as a RLP module. A portion of and/or a version of the RLP algorithm described below may be implemented by each of the vehicle control modules 12, roadside control modules 16, and the server control module 20. In addition, one or more levels of the RLP architecture disclosed herein may be implemented by the vehicle control modules 12, roadside control modules 16, and the server control module 20.

The vehicles 14 include the vehicles control modules 12 and transceivers 30 for vehicle-to-vehicle communication and communication with the other vehicle communication devices, such as communication with transceivers 32, 34 of the roadside devices 18 and the service provider 22. The vehicles 14 may also include sensor 19 such as cameras, lidar, radar, speed sensors. The roadside devices 18 may also include sensors 21 and traffic lights such as cameras or other devices to obtain geographic positions of objects. The service provider 22 may include a server 35, which includes the server control module 20, the transceiver 34, and a memory 36. The memory 36 may store vehicle information, such as that described herein, which may be shared with the vehicles 14.

The road user network may be a dedicated short range communication (DSRC) network, a cellular vehicle-to-everything (C-V2X) network, or other vehicle information sharing network including V2X communication. As an example, the DSRC network may be a 1-way or 2-way short to medium range wireless communication system using 75 mega-hertz (MHz) of spectrum in a 5.9 giga-hertz (GHz) band, which is allocated for transfer of automotive information.

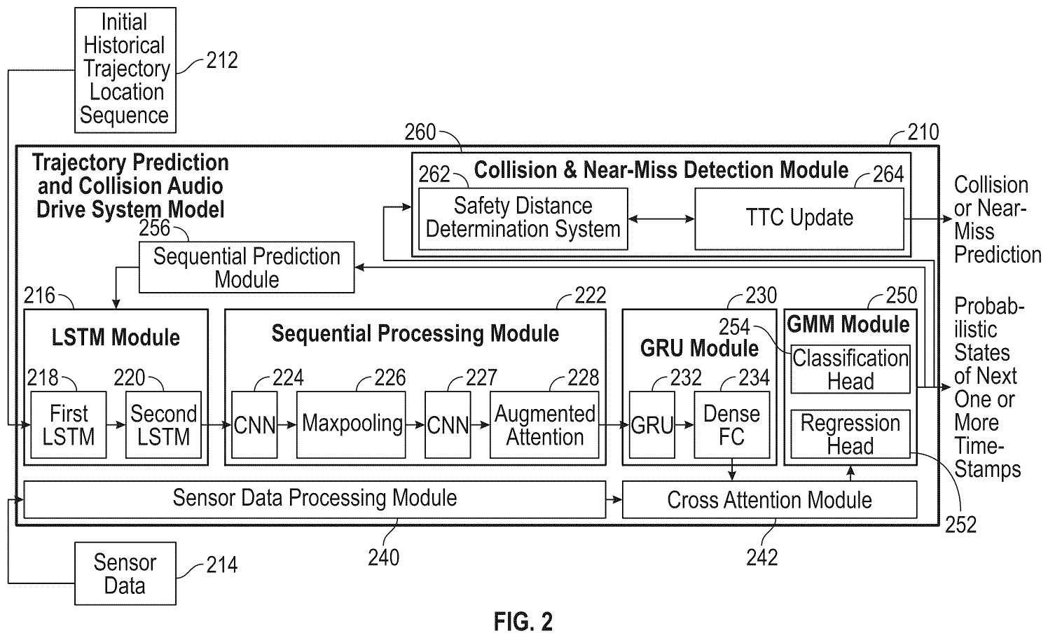

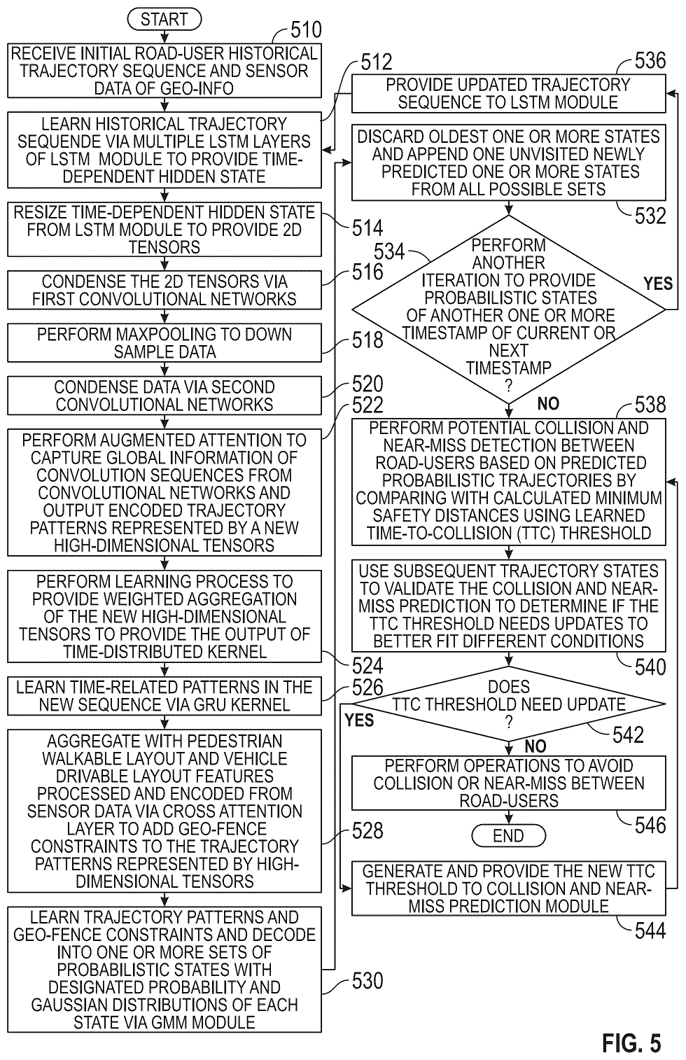

Referring now to FIG. 2 and FIG. 5, the service provider 22 may include a trajectory prediction and collision avoidance system model 210. Ultimately, the model 210 is used to control the vehicles 14, a roadside devices 16 (such as traffic signal and the timing thereof), or both. The model 210 receives historical trajectory data 212 that may be stored within the memory 36 within the vehicle information 38. The input to the model 210 is in shape of [m, 2], where m is the length of the historical trajectory and 2 describes the 2D location coordinate of latitude and longitude. Step 510 shows the historical data and sensor data input to the methods.

Details of the components in the model are provided briefly below and in more detail further below. In step 512, the model 210 includes a LSTM module 216 that has a first LSTM 218 and a second LSTM 220 that captures the time-related features from the historical trajectory and encodes them to a high-dimensional feature passing to time-distributed kernel or sequential processing module 222. An LSTM 216 is implemented as the first module of the architecture, having two LSTM models, each containing one layer, which is used to capture temporal feature from historical trajectory data and turn it into high dimensional time-ordered feature and outputs to the subsequent module. In step 512. The historical trajectory sequence is learned via the multiple layers (218, 220) of the LSTM 216 to obtain a time dependent hidden state. In step 514, two-dimensional tensors are obtained from the time-dependent hidden state.

Sequential processing module 222 first reshapes the tensor to higher dimension, and captures the high dimensional features by multi-layer CNN 224 and Maxpooling module 226. That is, the two-dimensional tensors are condensed using the CNN 224 in step 516. In step 518 maxpooling is performed to down sample the data from step 518. In step 520, the data is condensed using a second CNN 227.

An augmented attention module 228 captures global attention from the max pooling data. That is, in step 522 augmented attention is performed to capture lobal information (data) of convolutional sequences from convolutional networks and output encoded trajectory patterns represented by a new high-dimensional tensor. In step 524 a learning process is performed to provide weighted aggregation of the new high dimensional tensors to provide the output of time distributed kernels.

A GRU module 230 studies the sequential features again from new sequential feature output from the sequential processing module 222. The GRU module 222 has a GRU 232 and a dense FC 234. That is, in step 526, time related patterns are learned in the new sequence by way of the GRU kernel.

A sensor data processing module 240 receives the sensor data 214 and employs computer vision techniques to extract pedestrian walkable layouts and vehicle drivable layouts from input sensor data. It encodes the data into a high-dimensional feature, with same dimension as the output of GRU module 230, and then passes the data to a cross attention module 242.

In step 528, the cross-attention module 242 aggregates information from both GRU module 230 and the sensor data processing module 240. The cross-attention module 242 aggregates the two inputs and then outputs processed data to a GMM module 250. Essentially the geo-fence (sensor) data for objects such as sidewalks and driving lanes is encoded into the trajectory pattern represented by high-dimensional tensors. The geo-fence data may have geo-fence boundary data associated with various objects. Ultimately, the geo-fence data defines spatial boundaries or zones for monitoring road users. The GMM module 250 has a regression head 252 and a classification head 254.

In step 530, the GMM module 250 decodes the features into predicted probabilistic states of one or more time steps, which contains the position mean Trajectory Means (predicted probablistic trajectory) (μ\hat{ }t= [symbol] (x,y) [symbol] \hat{ }t∈R\hat{ }2) & Covariance (Σ\hat{ }t∈R\hat{ }(2×2)) at time t for mode k, as well as the probabilities of each mode.

In step 532, it is important to continually provide the best data. That is, step 532 discards the oldest one or more states and appends one unvisited newly predicted states from all possible sets.

In step 534, another iteration to provide probabilistic states of another one or more time stamp of the current time or the next timestamp may be performed. The probabilistic states are based on the historical and geo-fence data user for predicting future positions of road users. In step 534 if another iteration is to be performed step 536 provides updated trajectory sequence to the LSTM. In step 534 when another iteration is not to be performed, step 538 is performed. In step 538 a potential collision and near-miss detection between road users based on predicted probabilistic trajectories by comparing with calculated minimum safety distances using learned time-to-collision thresholds is performed.

In step 540 subsequent trajectory states are used to validate the collision and near-miss predictions or probability to determine if the time to collision (TTC) threshold needs updates to better fit different conditions. Thereafter, step 542 determines whether the time to collision update needs to be updated. When the TTC threshold does not need to be updated in step 542, step 544 generates and provides the new threshold to the collision and near-miss prediction module 260. In step 542, when the time to collision threshold needs to be does not need to be updated, step 546 performs operations to avoid collisions or near-misses between road users.

The predicted probabilistic state is provided to a sequential prediction module 256 sequential prediction module 256 passes the newly generated probabilistic state back to LSTM module 216 to start another iteration of predictions. The probabilistic states are sets of states with designated probability and Gaussian distributions for each state.

The predicted probabilistic state is provided to a collision and near-miss detection module 260 that includes a safety distance determination system 262 and a time-to-crash (TTC) update system 264. The safety distance allows a minimum safe distance to be maintained from other road users and prevent near-misses (less the safe distances).

In the sequential processing module 222, the first block, the CNN model 224, intakes the time-ordered high-dimensional data from the LSTM module 216, and then divides the input into m pieces, representing each time step of historical data. Through multiple layers (4-8 layers) of this module 224, the high dimensional feature is processed and condensed into m time-ordered matrices. Then, the maxpooling layer 226 and the augmented attention layer 228 are aimed to further squeeze the features and extract information from embedded sequence and then output to subsequent layers for decoding. Moreover, the output of sequential processing module 222 contains a large amount to information in which a large portion has long ago information. Thus, it needs to be processed in order to get only the most recent information.

The GRU 232 is positioned because the output of the cross attention module 242 also contains time-related embedded feature. GRU module 230 is able to output the most recent unit because the gate design of GRU model.

[symbol]

=GRU(F_{d})

While the model 210 is processing with the historical trajectory, the model needs to process with another input, which is sensor data 214 of the geographic data of the interest area. The sensor data processing module 240 is used for processing the input sensor data 214 with computer vision. Extracting the information of the position of crosswalks, sidewalks, driving lanes, etc. Encoding the extracted layouts into high-dimensional features with the same dimension as the GRU output and passes to data cross attention module 242.

After acquiring both processed input data, the cross attention module 242 is employed to aggregate them together for subsequent processing in step 528. The cross attention module 242 intakes two inputs, one is the high-dimensional embedded feature from the sequential processing module 222, and one is the constraint information of both pedestrian walkable layout data and vehicle drivable layout data. The two inputs share the same dimension and module aggregates those two information using a multi-head cross attention model 242 (MHCA). Here are the formulas to express the process. In the expression, F_{M}, Fₑ, F_{d} mean the features come from a trajectory mode information input, the CNN encoder 224 outputs features and the feature that is going to be input to the decoder:

$$Q = {F}_{M} + PE ( {F}_{M} ) \\ K = V = η ( {F}_{e} ) + η ( PE ( {F}_{e} ) ) \\ {F}_{d} = MHCA ( Q , K , V )$$

Where PE( ) is a positional encoding function; η( ) is a context search function, which addresses the attention of the local area of the object in the extracted layout; MHCA( ) is a multi-head cross attention layer.

Following the cross attention module 242, the final step is using two separate heads, the regression head 252 and the classification head 254 to acquire the probabilistic trajectory information encoded in the high dimensional feature output from previous layers. The classification head 254 calculates the probability of each possible location at the current time step,

p=MLP( [symbol] )

where p∈ [symbol] ^{K}. The regression head 252 calculates the detailed parameters of the Gaussian distribution of each location.

X=MLP( [symbol] )
where X∈ [symbol] ^{K×5}, is the GMM parameters representing K probabilistic trajectories at each single time stamp in total T future time prediction horizon right after the historical trajectory sequence. The 5 parameters are Trajectory Means (μ=(x, y)∈ [symbol] ²) & Covariance (Σ∈ [symbol] ^{2×2}).

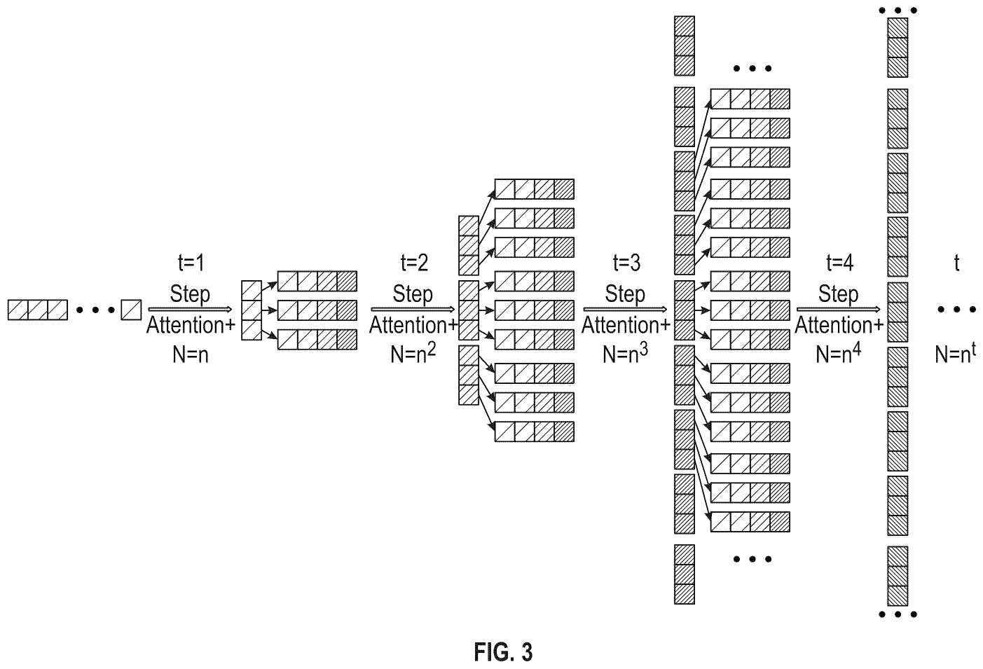

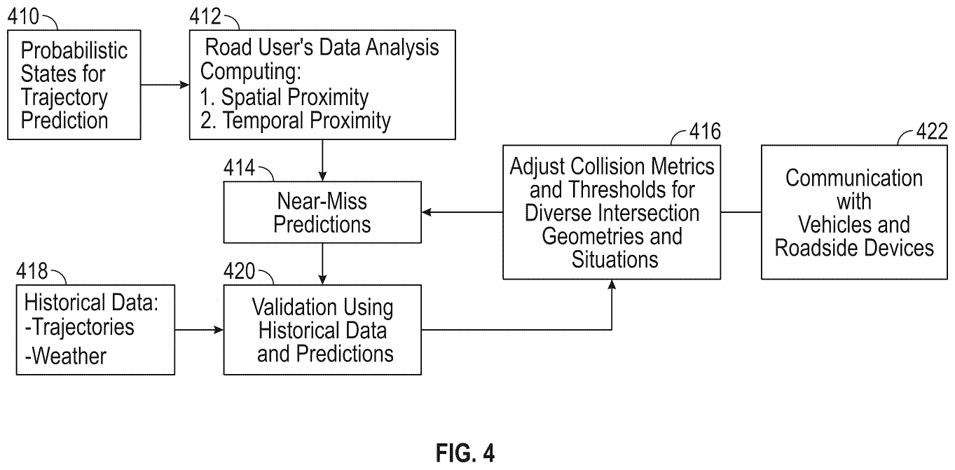

Referring now also to FIGS. 3 and 4, the model 210 intakes a series of historical data (coordinates) and give k probabilistic predicted locations (in this chart, k=3) for the next time step only. For each probabilistic predicted location, step attention will be processed for them and acquire another k probabilistic predicted locations for each one. Note that due to the constraints of the Geo-fence, there may not be exact k probabilistic states at each time.

In the end, after the predicted probabilistic trajectories of road-users are generated, by the GMM module 250 and as shown in block 410, the results are used for analysis of the potential collision and near-miss predictions (in near-miss block 414) between all road-users (vehicle-pedestrian, vehicle-vehicle, etc.) using the temporal data and spatial data from the road user's data analysis block 412. Since both the spatial and temporal information are obtained, it can be easily acquired by calculating the Euclidean distances of the coordinates of different road-users at the same timestamp. Spatial proximity data includes distance. If the distance d₁₂ between the predicted positions of road-user U₁ and U₂, L_{R}_{₁} and L_{R}_{₂}, is below a certain threshold dₘᵢₙ at timestamp t, then the road-user U₁ and U₂ has the risk of collision or near-miss in block 414. The vehicles 14 and roadside devices 18 may be controlled to avoid collisions and near-misses in block 416. That is collision metrics and thresholds for diverse intersections geometries and situations are considered in block 416.

Note that each predicted location at each timestamp has a probability, so the exact probability of this risk can be calculated by

$$P ( Risk of Collision or Near - Miss between {U}_{1} and {U}_{2} ) = P ( {L}_{{U}_{1}} ) \times P ( {L}_{{U}_{2}} )$$

The threshold of the near-miss judgement is varied through different conditions. Distance itself can be influenced by velocity of different road users. Thus, Time-to-Collision (TTC) to help determine the thresholds for different conditions may be used. Because time is the only factor that is fixed for near-miss detection and from the prediction results the user will have the probabilistic locations and the velocity at each time step within the T prediction horizon. By setting a constant risky TTC threshold τ, the distance threshold at time t between road user Uₐ and U_{b} at each time by equation may be determined by

$${d}_{m i n \vert t , a , b} = max ( τ \times \vert {v}_{x}^{a , t} - {v}_{x}^{b , t} \vert , τ \times \vert {v}_{y}^{a , t} - {v}_{y}^{b , t} \vert )$$

where vₓ^{a,t} representing the components of velocity of road user Uₐ in the x (latitude) direction at timestamp t, and the abs mark serves the purpose of getting the relative velocity.

But the TTC threshold cannot be constant in all cases, like sunny day and rainy day should have different TTC as the brake performance changes according to weather, road conditions, etc. To determine a most suitable TTC threshold t, another model is used to find out. After acquiring all the probability of the risk in one prediction, waiting for further information (data) from prediction results of the subsequent a few time steps is performed, and that data is used for the validation of the previous prediction, the near-miss determination, and the update for the TTC threshold of a specific weather or condition. That is, historical data is related to road users, including past trajectories, road conditions, traffic patterns, and weather data and are stored in block 418. The predictions may be validated in block 420. Block 420 communicated with block 416 so that the historical trajectories and the corresponding weather conditions are accounted for in the adjustment of the collision metrics in block 416. Ultimately, the roadside devices and road users such as vehicles 14 may have their respective operations adjusted in step 422 as data is communicated to the roadside devices and vehicles to mitigate collision risks. Other road users may include but are not limited to motorcycles, bicycles, and pedestrians. The control of the road user may include one or more of adjusting speed, travel path, or timing to avoid collisions of the road user.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method comprising:
obtaining historical data related to road users, including past trajectories, road conditions, traffic patterns, and weather data;
obtaining geo-fence data defining spatial boundaries or zones for monitoring road users;
generating probabilistic states for a future time based on the historical and geo-fence data, predicting future positions of road users;
determining spatial proximity data for a feature based on the geo-fence data;
generating a prediction based on the probabilistic state and the spatial proximity data, including trajectory, collision risk, or near-miss probabilities;
communicating the prediction to a road user or a roadside device; and
controlling the road user or roadside device based on the prediction, wherein controlling comprises adjusting speed, travel path, or timing to avoid collisions.

2. The method of claim 1 wherein the spatial proximity data is based on geo-fence boundaries determined from the geo-fence data.

3. The method of claim 2 wherein the geo-fence boundaries comprise at least one of lane boundaries and sidewalks.

4. The method of claim 1 wherein generating the prediction comprises generating the prediction based on temporal data.

5. The method of claim 4 wherein generating the prediction comprises generating the prediction based on the temporal data comprising road conditions and traffic patterns.

6. The method of claim 1 wherein the historical data comprises past trajectories and weather data.

7. The method of claim 1 wherein generating a prediction comprises generating a near-miss prediction.

8. The method of claim 7 wherein the near-miss prediction comprises determining a time-to-collision threshold for a plurality of road users.

9. The method of claim 8 wherein generating the near-miss prediction by comparing distances between road user using a predicted probabilistic trajectory and a minimum safe distance, and performing an operation when the distances are below a distance threshold.

10. The method of claim 7 wherein the near-miss prediction comprises determining a time-to-collision threshold at a plurality of time steps based on the probabilistic state and road user velocities.

11. The method of claim 9 wherein determining the time-to-collision threshold comprises dynamically adjusting the time-to-collision threshold dynamically based on updated weather and road conditions.

12. The method of claim 1 wherein controlling the road user or roadside device based on the prediction comprises controlling the road user by changing a speed or travel path.

13. The method of claim 1 wherein controlling the road user or roadside device based on the prediction comprises controlling the roadside device by changing a timing.

14. A system comprising:
a road user comprising vehicles, pedestrians, or mobile entities, equipped with sensors;
a roadside device which includes traffic lights, signs, or sensors designed to interact with road users;
a controller programmed to
receive historical data and geo-fence data, including past trajectories, road conditions, weather, traffic patterns, and geo-fence boundaries;
generate probabilistic states for a future time based on the received data, representing potential future positions;
determine spatial proximity data for a feature based on the geo-fence data;
generate a prediction based on the probabilistic state and the spatial proximity data, including future trajectories and collision risks;
communicating the prediction to the road user or the roadside device; and the road user or roadside device programmed to be controlled based on the prediction, including adjusting speed, path, or timing to mitigate collision risks.

15. The system of claim 14 wherein the spatial proximity data is based on geo-fence boundaries from the geo-fence data.

16. The system of claim 14 wherein the geo-fence boundaries comprise at least one of lane boundaries and sidewalks.

17. The system of claim 14 wherein generating the prediction comprises generating the prediction based on temporal data.

18. The system of claim 14 wherein the historical data comprises past trajectories and weather data.

19. The system of claim 14 wherein the controller is programmed to generate a near-miss prediction based on a time-to-collision threshold for a plurality of road users.

20. The system of claim 19 wherein the controller is programmed to determine the time-to-collision threshold by dynamically adjusting the time-to-collision threshold dynamically based on updated weather and road conditions.
